(19) United States
(12) Patent Application Publication
(10) Pub. No.: US 2004/0212273 A1
(43) Pub. Date: Oct. 28, 2004

(54) Heat engine and generator set incorporating multiple generators for synchronizing and balancing

(76) Inventor: Len Charles Gould, Brampton (CA)

Correspondence Address: Mr. Len C. Gould, 43 Copeland Road, Brampton, ON, L6Y 2S5, CA

(21) Appl. No.: 10/421,825

(22) Filed: Apr. 24, 2003

(51) Int. Cl. H02K 1/12

(52) U.S. Cl. 310/254; 310/268

(57) ABSTRACT

The invention is two new ways of constructing a synchronous dynamo electric machine having either permanent magnet or electrically excited field poles and no active electrical or magnetic parts attached to the rotor. Also shown is a means of using one or more such machines connected to prime mover engines to synchronize rotation or dampen vibration within the engines as well as acting as a motor or generator. Further shown is a means of constructing a dynamo electric machine in a configuration which particularly suits application as an auxiliary alternator on an automotive piston engine.

### RELATED APPLICATIONS

NA

### STATEMENT REGARDING FEDERALLY SPONSORED RESEARCH OR DEVELOPMENT

Not applicable

U.S. Patent Documents

| | | | |
|---|---|---|---|
| 3,629,626 | December 1971 | Abbott | 310/49 |
| 3,555,330 | January 1971 | Svecharnik | 310/68 |
| 4,027,229 | May 1977 | Frink | 310/190 |
| 4,048,531 | September 1977 | Buess et al. | 310/49 |
| 5,053,666 | October 1991 | Kliman et al. | 310/261 |
| 5,294,857 | March 1994 | Auinger et al. | 310/269 |
| 5,448,117 | September 1995 | Elliott | 310/49 |
| 5,459,385 | October 1995 | Lipo et al. | 318/701 |
| 5,537,019 | July 1996 | Sistine et al. | 318/701 |
| 5,670,838 | Sep. 23, 1997 | Everton | 310/254 |
| 5,767,601 | Jun. 16, 1998 | Uchiyama | 310/190 |
| 5,717,269 | February 1998 | Tang | 310/168 |
| 5,793,139 | August 1998 | Nashiki | 310/216 |
| 5,834,866 | November 1998 | Fujitani et al. | 310/49 |
| 5,998,902 | Dec. 7, 1999 | Sleder et al | 310/91 |
| 6,111,334 | August 2000 | Horski et al. | 310/254 |
| 6,198,190 | Mar. 6, 2001 | Umeda et al | 310/179 |
| 6,278,212 | Aug. 21, 2001 | Kalsi | 310/162 |
| 6,323,573 | Oct. 27, 2001 | Pinkerton | 310/178 |
| 6,424,126 | Jul. 23, 2002 | Ohsawa | 322/4 |
| 6,356,001 | Mar. 12, 2002 | Nishiyama | 310/156.3 |
| 6,462,430 | Oct. 8, 2002 | Joong et al | 290/40C |
| 6,495,941 | Dec. 17, 2002 | Nishimura | 310/68 |

Foreign Patent Documents

Inventor: Gould, Len C (43 Copeland Road, Brampton, Ontario, Calif.)

Assignee:

Current U.S. Class: 310/

Intern'l Class: F02M 51/02

Field of Search: 310/$; 310/254; 336/210,211,212,213,216,217,218,219,233

Primary Examiner:

Assistant Examiner:

Attorney, Agent or Firm: None

### FIELD OF THE INVENTION

The present invention relates to a dynamo-electric machine applicable to a motor and generator set and, more particularly, to a dynamo-electric machine that is directly coupled to the output points of a heat engine to be used for purposes including starting the engine, for generating power, for synchronizing rotation of various parts of the engine and for dynamically harmonically balancing that engine. The present invention also demonstrates a novel means of cooling one type of such a dynamo machine, and a novel means of incorporating a useful such dynamo machine into close fitting spaces.

### BACKGROUND OF THE INVENTION

### Prior Art

It is known to employ a dynamo machine to generate useful electrical energy from a heat engine, and also to act as a motor for starting of the heat engine. In particular the advantages of a solid sate commutated alternating current generator in simplicity of design and range of useful rate of rotation have seen them entirely replace mechanically commutated DC generators in automotive use over the past 30 years.

More recently the increasing demands of auxiliary loads and the increasing application of hybrid mechanical electrical drive trains has created a need for a review of the entire relationship of alternators with heat engines.

The current state of the art of fast high voltage solid state power electronics combined with the capabilities of modern digital control systems offers an opportunity to logically redesign the relationship of a heat engine to the generation of electricity.

Present day auxiliary power alternators, well represented by Umeda et al in U.S. Pat. No. 6,198,190, among others, is typically a 3 phase 2 or 4 pole claw pole synchronous machine with a dynamically excited rotor connected to a regulator by slip rings and the power circuit commutated by a full wave diode bridge rectifier. This machine does a decent job of cheaply and fairly efficiently generating enough power to charge a starting battery and operate typical automotive auxiliaries throughout the typical rpm range of an auto engine, e.g with approximately a 3:1 belt drive ratio it can produce sufficient battery charging voltage from 500 to 5000 engine rpm without melting or flying apart. It suffers at least 5 weaknesses which need to be addressed. 1) Engines are being made to idle now at ever lower rpm, meaning these machines need to expand their dynamic range, which is a problem since the required increase in excitation power needs to be passed by a fairly complex path of slip rings to the rotor coil. 2) Heat buildup/cooling is already a problem, limiting the potential of permanent magnets to be used to enhance excitation power, since permanent magnets have strict limits to the temperatures which they will abide. At any rate the potential for use of main or auxiliary permanent magnets in a typical claw-pole rotor design is quite low. 3) The need for an uprate ratio in the drive usually demands either a belt drive or a gear drive, both of which waste energy and cost money. 4) The alternaor design does not lend itself to combined use also as a starting motor due to the upratio rate of the drive, among other reasons. 5) At higher rpm much generated energy is simply wasted into heat in order to keep the output voltage low enough to safely apply to the battery.

Present day power alternators designed for the main drive of hybrid automobile drive trains are predominantly either permanent magnet rotor three phase two to four pole machines, with some interest still in synchronous reluctance rotor machines and some discussion of hybriding of inductance rotor designs. These designs are well represented in U.S. Pat. No. 6,462,430 by Joong et al or U.S. Pat. No. 6,424,126 by Ohsawa among others. In general, little attention is paid to the relationship of the generator to the engine, with much of the design effort focused on the convenience of the drive system electronics among other goals. As a main drive alternator, the permanent magnet rotor dynamo machine design suffers several weaknesses. 1) Permanent magnet rotors are highly suseptible to de-magnetization from over-temperature or vibration. 2) Permanent magnets do not contribute well to the structural integrity of the rotor, in fact magnetic and mechanical design priorities directly conflict. 3) The new high power permanent magnet materials are highly suseptible to flux overloading or saturation, being already very near their limit. Therefore auxiliary dynamic coils used for excitation control must normally be bucking rather than boosting in their control direction. This means that for a given design, the auxiliary dynamic coil current, and therefore energy waste and heat generation, must be at maximum at low to medium voltage or power outputs, which is where most automobile systems spend the large majority of their time. It would be preferrable for a field coil current design to have the opposite characteristic, e.g. at minimum coil current when the generator is at minimum power. 4) A permanent magnet rotor design typically imposes significant restraints on the ratio of rotor width to diameter in order to maintain acceptable pole saliency. This is the most problematic of all shortcomings of a permanent magnet rotor.

To the purpose of combining the functions of power generation and compensating mechanical oscillations within dynamo electric machines, Auinger et. al. propose providing auxiliary windings on the salient poles of a rotor of a synchronous machine to the end of improving the relationship of a synchronous generator of pre-determined electrical and magnetic design with a piston engine prime mover. Others in prior art describe installing damper shoes and other means to the same end. None propose re-engineering the pole count, phase count or primary exciter logic pased on the prime mover inherint charactistics to this end, presumeably since the grid to which they propose connnecting the output of the generator generally pre-establishes the electrical and magnetic characteristics of the generator to e.g. 50 or 60 hz 3 phase, leaving little flexibility. An alternator for an isolated system such as an automobile where the output power will be rectified to DC before use at any rate should ignore these restrictions to the benefot of the prime mover engine.

The balance of the state of the art is well represented by e.g. John Everton of Britain in U.S. Pat. No. 5,670,838, by Dr. Milutin Javanovich of University of Newcastle in his PhD thesis “Sensorless Control of Synchronous Reluctance Machines”, by Dr Heath Hofmann of Berkley in “Flywheel Motor/Alternator Design for Hybrid Electric Vehicles”, or Jingdong Chen of University of West Virginia in “Nonlinear Transient and Steady State Analysis for Self-Excited Single Phase Synchronous Reluctance Generator” among many others. In summary, here again the focus is entirely on the alternator as an electrical machine with no attention paid to its dynamic relationship to its prime mover.

Pinkerton in U.S. Pat. No. 6,323,573 takes steps to address some of these problems, but fails to achieve a sufficient energy density within the motor to be very useful.

Nishimura in U.S. Pat. No. 6,495,941 comes very close from a strictly electrical engineering point of view with a design which might be capable of addressing some of the above mentioned problems, but then ignores the potential to assist and simplify the prime mover engine. An additional problem of existing alternator designs including that of Nishimura, in particular those of relatively compact and high frequency design, is magnetic flux leakage across pole pieces which are very closely spaced within the stator. Also a problem is the small pole faces presented at the interface of the stator and the rotor meaning that the pole piece material will approach saturation at fairly low power which will further contribute to the flux leakage problem.

A further area of problem which needs the assistance of a novel dynamo-electric machine design is in the application of the gerotor compressor-expander as a prime mover heat engine generator set. In U.S. Pat. No. 6,336,317 Hortzapple teaches the use of gerotors as compressor and expander in a heat engine. There remains in the designs he shows a difficulty of needing to independently synchronize the inner rotor with the outer rotor, since no lubricant can be supplied to the rotor surfaces during operation. A separate gear set is proposed by Hortzapple, but these create a difficulty of themselves requiring lubrication in a position which is very close to hot gases at a temperature beyond the withstand capability of any common lubricant.

A separate further problem common to all current designs of automotive auxiliary alternators is that of providing sufficient cooling to the magnet steel and the coil windings. Air cooling fans in current alternator designs normally add their width to the width of the alternater, which increases the bulk size of the package in an environment where package size is important. Allowing the alternator to participate in the engine coolant circuit would reduce the package size for a given alternater capacity.

### SUMMARY OF THE INVENTION

It is a first object of the present invention to show a means of applying one or more dynamo electric machines to one or more power output points of a heat engine for one or more of the purposes of a) synchronizing rotation of various engine parts b) dynamically harmonically balancing the rotating elements c) dynamically applying a non-rotating force vector to the heat engine connection point to counteract and opposite non-rotating force vector inherent in the heat engine design, in addition to the standard primary purposes of c) starting the engine or d) generating output electrical power.

It is a secondary object of the present invention to show a first novel means of constructing such a dynamo electric machine in the lundel fashion but having the extended pole pieces of the exciter directly interleaved with the pole pieces of the stator and making contact with the faces of pole pieces installed within the rotor, and a second novel means of constructing such a dynamo electric machine in the lundel fashion but having the extended pole pieces of the exciter reaching down the sides of the stator to effect magnetic circuit contact at the side surfaces of pole pieces installed within the rotor.

It is a tertiary object of the present invention to show an optional means of constructing such a dynamo electric machine in a configuration to suit the space available at the standard harmonic balancer point of an automobile piston engine.

It is a further object of the present invention to show how to exploit the natural hollow core of the dynamo electric machine design shown to incorporate a turbine blower to pressurize cooling air to cool the machine or for other purposes.

To the first object, it is simplest to first illustrate the application of the dynamo to the gerotor compressor and expander. They need a system to initiate rotation at starting in order to compress working fluid in the high pressure working fluid circuit to be heated and fed to the expander. Capability to operate as a motor is a first requirement on the design. Capability to then operate efficiently as an alternating generator at high rotational frequencies is a second requirement.

The gerotor machines are constructed with an inner and outer rotor independently supported on bearing pairs with the inner rotor having one less axial protrusion than the number of mating cavities in the outer rotor, resulting in the inner rotor rotating at a higher rate than the outer rotor. This ratio creates a third requirement on the synchronizing alternators, which need to create their power drawn from the engine at different speeds.

The power extracted from the hot gases in the expander is transferred approximately equally to the inner and outer rotors. The power output has a pulsed waveform with a sawtooth shape, being at minimum on both the inner and outer rotors as an expansion chamber is first fully revealed to the exhaust port, then rising fairly smoothly to a peak as greater surface areas are presented to the working fluid at the inlet port during rotation. This waveform and its harmonics create a fourth requirement on the synchronizing alternators, in that they need to adjust their power draw from the engine in a manner matching the rise and fall of this waveform. An additional requirement is imposed by the internal pressures on the rotors being unbalanced circumferentially, being at high pressure on that half of the rotor surfaces between the inlet port and the outlet port, and at low pressure on the remaining half. This unbalanced load, though not enormous, imposes sufficient load on the supporting bearings to cause air bearing designs to be large and or high pressured, making them more expensive. A good alternator design will contribute to the reduction of this unbalanced load.

To the purpose of satisfying the first object, a pair of alternator are constructed, the first being driven by the the outer rotor and the second being driven by the inner rotor. These alternators are electrically designed as three phase AC synchronous machines to make maximum use of the copper in the windings. In order to usefully employ the machines to synchronize the rotors, their pole counts are then set to match the configuration of the rotors by which they are driven, e.g. 5n poles on the outer rotor and 4n poles on the inner rotor. The windings and pole pieces are then designed so that at all rotation rates the two alternators generate equal voltage and power at a rate to match the mechanical power of the two rotors.

One method to accomplish this end interleaves the exciter pole pieces with the power pole pieces in a common stator. The rotor then carries matching rotor pole pieces capable of interconnecting alternating magnetic exciter poles to each power pole. These rotor pole pieces are installed at a ratio of 4 to 3, that is 4 rotor pole pieces for each 3 stator pole piece. With this information, formulae can be written to design stators and rotors as follows:

Phase×Lobes×2n=Stator Pole Pieces

Stator Pole Pieces×4/3=Rotor Pole Pieces

For the above example with a 5 by 4 rotor ratio, the results might be

Outer Alternator Stator Pole Pieces 3×5×2=30

Inner Alternator Stator Pole Pieces 3×4×2=24

Outer Alternator Rotor Pole Pieces 3×5×2×(4/3)=40

Inner Alternator Rotor Pole Pieces 3×4×2×(4/3)=32

The design result is an “outer rotor” alternator which when turned at 8,000 rpm will generate 3 phase AC power at 5.4 kHz, and an “inner rotor” alternator which when turned at 10,000 rpm will generate 3 phase AC power at 5.4 kHz. This means the two alternators can be directly connected together at their AC terminals, then the DC excitation current of each machine can be adjusted individually to match the particular characteristics of each rotor during operation.

Generating AC power at 5.4 kHz is about the same as modem automobile alternators and not out of the range of current diode rectifier or laminated pole piece capability, since e.g. Elna Magnetics Corporation advertises several laminate materials for the purpose which have quite flat hysteresis loss curves up through 300 kHz, and the design shown here has a relatively small cross section of high frequency metal pole pieces.

To handle the pulsations in power of the sawtooth form discussed above, a matching AC waveform is generated electronically in an independent control circuit for each alternator, then imposed on the DC excitation circuits individually in a manner to cause the output power of each alternator to vary according to the microstructure of the mechanical input power.

The resulting alternators can then be electrically connected directly to each other at their AC outputs, resulting in an accurate synchronization of the two rotating members if all the engine power is to be taken off as electrical power. If all or part of the engine power must to be taken off as mechanical power from the shaft through the inner engine rotor, then additional microstructure is imposed on the DC excitation current of each dynamo machine to cause the outer alternator to act as a generator in exact synchronization with the inner alternator acting as a motor, thus transferring the power from the outer rotor to the shaft without imposing stress on the contact points of the two engine rotors.

In this way the two engine rotors can be operated safely at high speeds with little or no separate mechanical synchronizing. Sliding contact between the two rotors is accepted at this level since pressure is maintained low enough that the contact will not deteriorate the rotor surfaces during their design life. This provides the added efficiency of reducing gas leakage which would occur at this gap if a gear system maintained a fixed separation of the two rotors as recommended by Hortzapple.

The same technique can be applied to multi-cylinder piston engines, which experience pulsed power output in a ratio of half the cycle count×cylinder count×vertical cylinder bank alignment/360. There is also a dramatic sawtooth component of the power pulses as the power stroke gas pressure starts high and drops off, and a somewhat negative sawtooth component as the pistons execute their compression stroke, with other harmonics introduced by crankshaft and rod flexing, valvetrain loads and a myriad of other component issues.

Current methods of dealing with these problems include installation of a harmonic balancer, usually a viscous core flywheel at the front of the engine and off-speed balancing shafts parallel to the crankshaft. Replacing the front harmonic balancer with an auxiliary alternator of the present design will do a better job of damping these pulsations. In a hybrid electric drive vehicle, an alternator pair of the present design will enable practically silent operation. In the simple case where the engine is not used in a hybrid drive, the harmonic balancer and auxiliary drive pully at the front of the engine is replaced by the rotor of an alternator which has the following electrical design.

The smallest rotation angle, call it the bank angle, which can evenly separate all power pulses in the engine is then calculated or developed by inspection. e.g. for a 4 cycle inline 6 engine, this angle is 120 degrees., for a 4 cycle 90 degree V8 engine, this angle is 90 degrees, for a 4 cycle 90 degree V6 engine, this angle may be 30 degrees

Rotor Pole Piece Count=360/Bank angle×Phase×Rotor/Stator Ratio×2

note: the ×2 at the end simply provides for there always being a North excited AC winding and a South excited AC winding connected in series whenever power is generated. This may simply be old habit, since there appears to be no reason to maintain this requirement, and a designer should consider dropping the requirement provided the magnetic pathways are maintained.

Thus for an example Inline 6 cylinder 4 stroke engine, the pole count works out to:

360/120=3 pole pairs, giving 3×3×2×4/3=24 Rotor pole pieces

Thus for an example 90 degree V8 4 stroke engine, the pole count works out to:

360/90=4 pole pairs, giving 4×3×2×4/3=32 Rotor pole pieces

Thus for an example 90 degree V6 4 stroke engine, the pole count works out to:

360/30=12 pole pairs, giving 12×3×2×4/3=96 Rotor pole pieces

If a stator interleaved exciter pole structure is to be used, then Stator Pole Pieces=3/4×Rotor Pole Pieces, otherwise Stator Pole Pieces=Rotor Pole Pieces×Phase Count.

Consideration now goes to space provisions at the front of the engine. With this alternator design, it is not necessary to completely surround the rotor with stator. The stator may be restricted to only for example 120 degrees of the full circle, provided it is balanced for pole count and phase count×2. The required output power given the stator percentage surround then determines the size of the pole pieces and the copper, which then establish the width and diameter of the rotor.

An alternator rotor is then constructed to fit to the front of the crankshaft having either equal or 4/3 as many pole pieces as the stator. If other auxiliary equipment is to be belt driven from the crankshaft, e.g. water pump, A/C compressor, fan etc., then a pulley is mounted to the front of this rotor. Consideration should be given to driving these other auxiliaries electrically from the new alternator preferrably from the 3 phase AC output directly to reduce inverter costs, but also possibly from the rectified DC output, as this enables the alternator size to increase to a point where it can be more effective as an active damper and might enable it to then replace the engine starter motor as well. The ruggedness of this rotor design means no enclosure is required except possibly for a thin coating of protective non-magnetic material over the exposed laminated pole peices embedded within the rotor face.

The alternator stator is constructed and encased completely within a suitable housing which includes a thin annealed and non-magnetic stainless steel sheet at the pole faces. A communicating passage set may be provided to the engine coolant if necessary. The stator is attached to mounting provisions at the front of the engine block, and the alternator power leads are connected as usual.

The regulator for the alternator is then assigned the task of active damping for the engine, by having a suitable sawtooth waveform imposed on the DC current. The regulater can most logically have its exciter current waveform managed by the same control unit which also manages fuel injection and spark for the engine, since the requisite base waveforms are generated there. The regulater can then as required contribute additionally to damping by possibly introducing additional harmonics to the exciter current waveform, these possibly also commanded by the engine ECU based on rpm, load etc.

The potential for the most useful active harmonic damping of a piston engine in this manner increases significantly if the entire load of the engine is assigned to two alternators of this design connected at each end of the crankshaft and having their AC windings tied together and their DC excitation generated uniquely for their position on the engine.

It can be seen also that the nature of this alternator design also allows for different segments of the stator to be assigned to different purposes electrically, provided the rotor pole peices are sized and designed to handle the largest of the requirements and the pole piece counts can be matched up. For example a stator can be designed so that 72 degrees of the stator is an auxiliary battery charger producing an output of 2 KW at 13.5 VDC rectified and having its own regulater, exciter windings and AC windings, while the remaining 288 degrees of the stator circumference may be wound as a main circuit driving alternator and starting motor for a hybrid vehicle, generating an output of e.g. 600 VDC at 8 KW for the main drive system. Many other options are possible.

Due to the hollow core design of the rotor of this alternator design, it is also possible to incorporate a turbine fan into the center of the rotor between the hub and the pole pieces to provide pressurized air at fairly high static pressures and volumes for winding and pole piece cooling or other purposes.

### DESCRIPTION OF THE DRAWINGS

In drawings which illustrate embodiments of the invention:

FIG. 1 is a perspective image partly cut away of a dynamo electric machine constructed according to a first preferred embodiment of this invention.

FIG. 2 is a longitudinal section through the machine of FIG. 1

FIG. 3 is a radial section through the machine of FIG. 1

FIGS. 4, 5 and 6 illustrate the movement of the rotor of FIG. 3 through one electrical cycle.

FIG. 7 is a perspective image partly cut away of a second dynamo electric machine constructed according to a second preferred embodiment of this invention.

FIG. 8 is a longitudinal section through the machine of FIG. 7

FIG. 9 is a radial section through the machine of FIG. 7

FIGS. 10, 11 and 12 illustrate the movement of the rotor of FIG. 9 through one electrical cycle.

FIG. 13 is a section through a gerotor engine of prior art to which the present invention can be applied.

FIG. 14 is a section through the same gerotor engine as in FIG. 13 additionally illustrating the application of the present invention to synchronize the rotors of a gerotor engine. FIG. 14 also illustrates the placing of a cooling air blower within the rotor according to the present invention.

FIG. 15 is a perspective image of a dynamo electric machine constructed according to a third preferred embodiment of the present invention illustrating a stator which surrounds less than 360 degrees of the rotor and having the rotor replace the harmonic balancer at the front of a piston engine such as might be used in an automobile.

FIG. 16 is a longitudinal section through the dynamo electric machine of FIG. 15

FIG. 17 is a radial section through the dynamo electric machine of FIG. 15

### DETAILED DESCRIPTION OF THE INVENTION

In all preferred embodiments of the invention shown in Figures, similar parts are referenced by the same numbers.

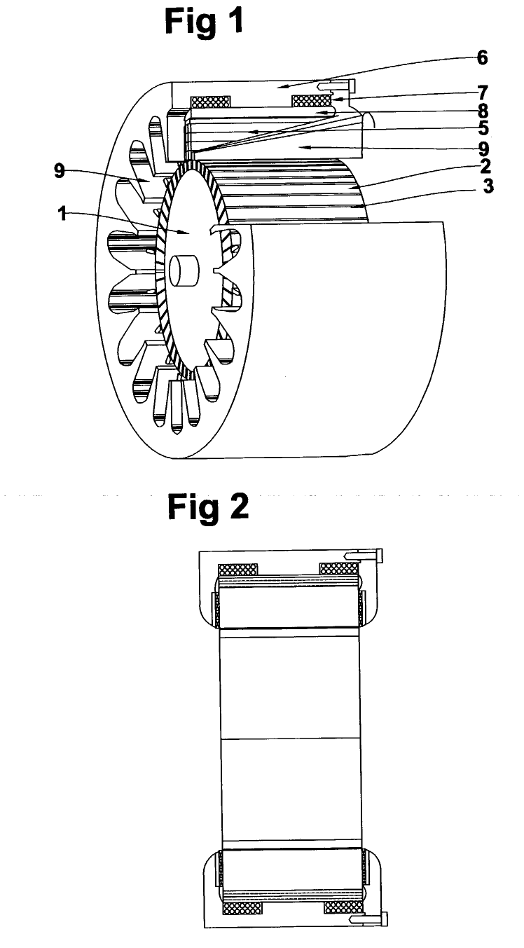

In FIG. 1 is a perspective image partly cut away of an example dynamo electric machine constructed according to a first preferred embodiment of this invention. The rotor has embedded within its non-magnetic body 1 thin magnetic steel plates laminated into magnetic poles 2 separated by non-magnetic material 3 such as annealed stainless steel or aluminum. A laminated magnetic inner stator is comprised of thin magnetic steel plates forming a cylindrical core 4 with a number of teeth having coils wound about them 5 and projecting from the core toward the rotor. The teeth are equally spaced about the core and consist in number [pole count]×[phase count]. The number of the magnetic poles 2 installed into the rotor is [pole count]×[phase count]×[phase count]/[phase count+1]. In the example in FIG. 1, there are 36 teeth projecting, creating a 12 pole 3 phase alternator, which at a rotation rate of 4000 rpm will generate AC at 800 hz, a frequency easily converted to DC by a low cost diode bridge. The outer radial circumference of the stator is comprised of an exciter pole structure having a solid circumferential band 6 formed of a solid magnetic material or optionally of a permanent magnetic material, surrounding DC exciter coils 7 at a distance 8 to provide magnetic separation between the exciter pole structure and the inner core structure. Longitudinally projecting fingers 9 are then formed about the outer circumference of the exciter pole structure in a manner that the fingers project horizontally between the teeth and coils of the cylindrical core, alternately from one side and then from the other side and in very near proximity to the rotor.

In FIG. 2 is an axial section through the center of the alternator in FIG. 1 illustrating in more detail the internal structure of the alternator.

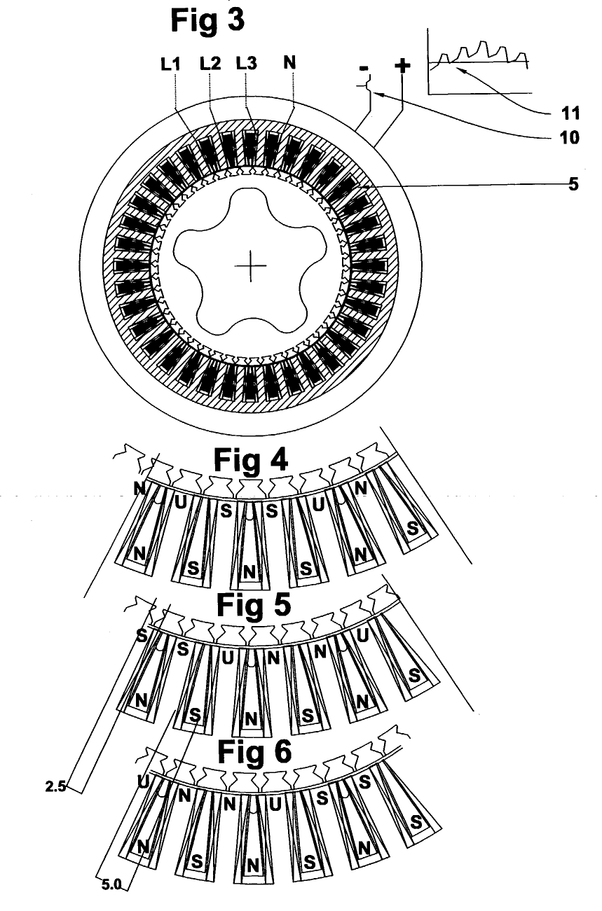

In FIG. 3 is a radial section through the center of the alternator in FIG. 1 illustrating in more detail the electrical structure of the alternator. As anyone skilled in the art can see, the AC coils 5 can quite simply be connected in a series and/or parallel Y or Delta connection as required by the designer to achieve any of a variety of goals with the alternator. The exciter driver device 10 can be easily managed by any of a wide variety of driver circuits to achieve any one or more of the aims stated in claims by generating AC frequencies imposed onto the DC exciter current as illustrated at 11, which shows graphically the exciter current for one rotation of the alternator where a half sine waveform at 1 cycle per rotation designed to deal with a vibrational harmonic within the rotating mechanism has superimposed on it a 5 cycle per rotation sawtooth waveform designed to counteract or smooth out the power pulses of a 5 lobe gerotor outer rotor acting as an expander in a heat engine.

In FIGS. 4, 5 and 6 is a detail of part of FIG. 3, illustrating the rotor pole to stator tooth relationship through one electrical cycle of the example alternator or 5 degrees of rotation.

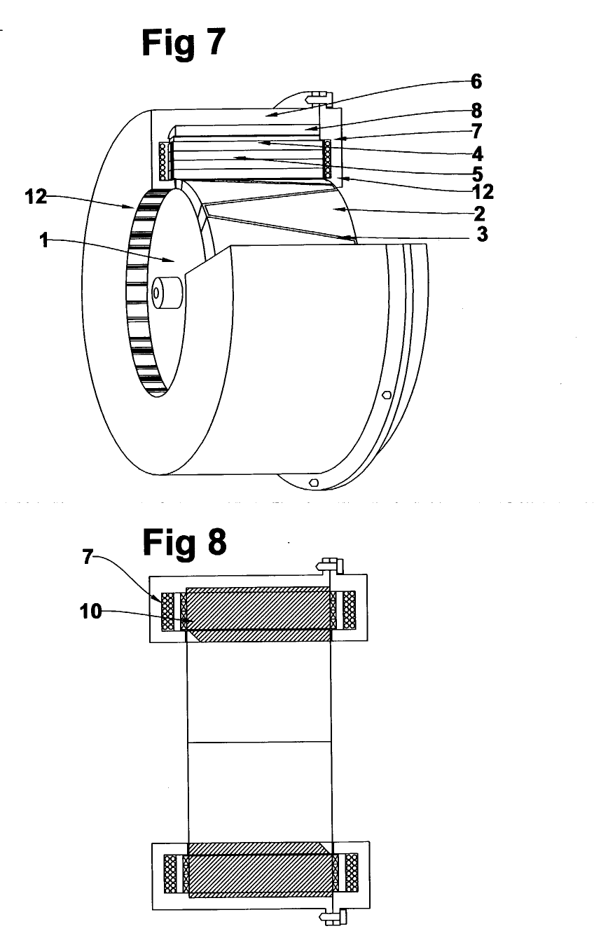

In FIG. 7 is a perspective image partly cut away of an example dynamo electric machine constructed according to a second preferred embodiment of this invention. The rotor has embedded within its non-magnetic body 1 solid magnetic steel poles 2 separated by non-magnetic material 3 such as annealed stainless steel or aluminum. The poles are formed so that alternate poles present an end to onlt one of opposite sides of the rotor and remain magnetically separate from the other sides. A laminated magnetic inner stator is comprised of thin magnetic steel plates forming a cylindrical core 4 with a number of teeth having coils wound about them 5 and projecting from the core toward the rotor. The teeth are equally spaced about the core and consist in number [pole count]×[phase count]. The number of the magnetic poles 2 installed into the rotor is equal to the number of teeth in the stator lamination divided by the phase count. In the example in FIG. 7, there are 36 teeth projecting, creating a 4 pole 3 phase alternator, which at a rotation rate of 4000 rpm will generate AC at 266 Hz, a frequency easily converted to DC by a low cost diode bridge. The outer radial circumference of the stator is comprised of an exciter pole structure having a solid circumferential band 6 formed of a solid magnetic material or optionally of a permanent magnetic material, surrounding the above inner stator and DC exciter coils 7 at a distance 8 to provide magnetic separation between the exciter pole structure and the inner stator structure. Radially projecting rings 12 are then formed about the outer circumference of the exciter pole structure in a manner that the rings project to very near proximity to the side faces (shown) or other surfaces (not shown) at the ends of the rotor proximate the ends of alternate poles embedded into the rotor.

In FIG. 8 is an axial section through the center of the alternator in FIG. 7, illustrating in more detail the internal structure of the alternator. In particular is illustrated more clearly the relationship of the rotor poles to the exciter rings if the exciter rings are to approach the side faces of the rotor, having each pole piece projecting only to one exciter ring or the other alternately, causing alternate pole pieces to be continuously excited either North or South magnetically.

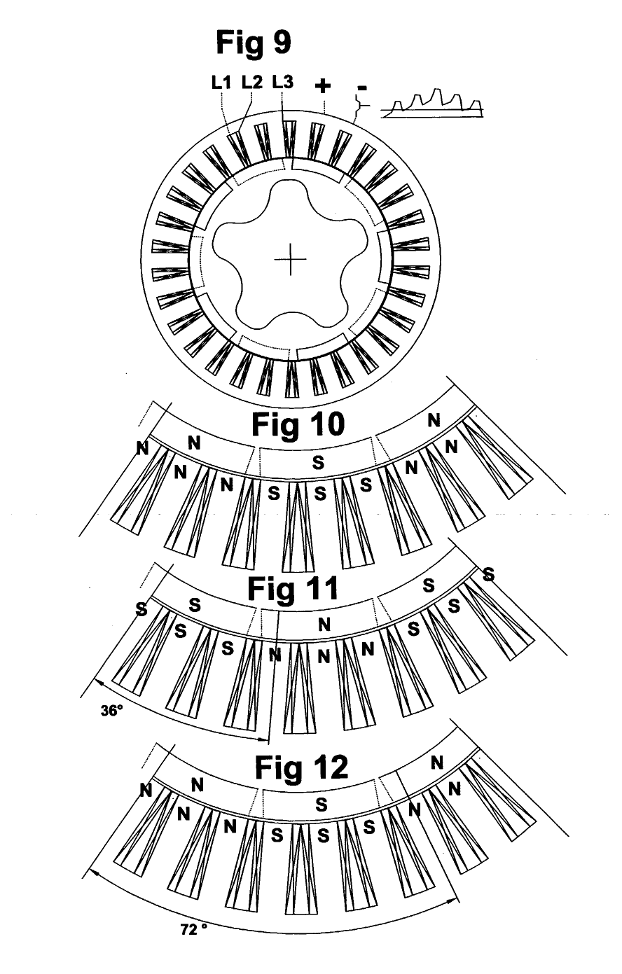

In FIG. 9 is a radial section through one end of the alternator in FIG. 7 illustrating in more detail the electrical structure of the alternator. As anyone skilled in the art can see, the AC coils 5 can quite simply be connected in a series and/or parallel Y or Delta connection as required by the designer to achieve any of a variety of goals with the alternator. The exciter driver device 10 can be easily managed by any of a wide variety of driver circuits to achieve any one or more of the aims stated in claims by generating AC frequencies imposed onto the DC exciter current as illustrated at 11, which shows graphically the exciter current for one rotation of the alternator where a half sine waveform at 1 cycle per rotation designed to deal with a vibrational harmonic within the rotating mechanism has superimposed on it a 5 cycle per rotation sawtooth waveform designed to counteract or smooth out the power pulses of a 5 lobe gerotor outer rotor acting as an expander in a heat engine.

In FIGS. 10, 11 and 12 are details of part of FIG. 9, illustrating the rotor pole to stator tooth relationship through one electrical half cycle of the example alternator, or 30 degrees of rotation.

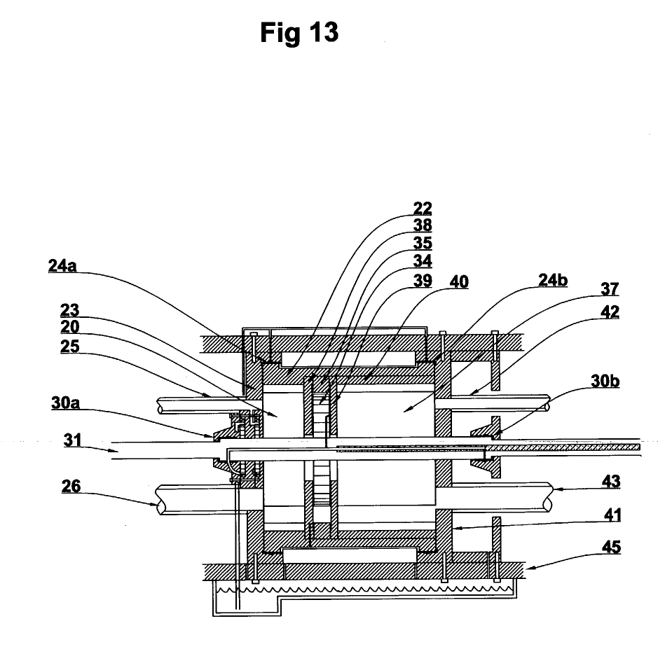

In FIG. 13 is a section through a gerotor engine of prior art to which the present invention can be applied. At 20 and 21 are the inner and outer gerotor rotors of a gerotor compressor rotating with casing 22 between valve plate 23 and separator plate 38. At 37 and 40 are the inner and outer gerotor rotors of a gerotor expander also rotating with casing 22 between valve plate 41 and separater plate 39. Between them is disposed a gear pair 34 and 35 operating to synchronize the rotation of the two gerotor rotor pairs. The compressor outlet is at 25 and its inlet is at 26. The expander inlet is at 42 and its exhaust is at 43. Shaft 31 rotatably supports the inner gerotor rotors and the inner gear of the gear pair on bearings 30a and 30b. Enclosure 45 rotatably supports the outer gerotor rotor casing 22 on bearings 25a and 25b. Auxiliary systems not detailed additionally contribute to the operation of the system as a heat engine.

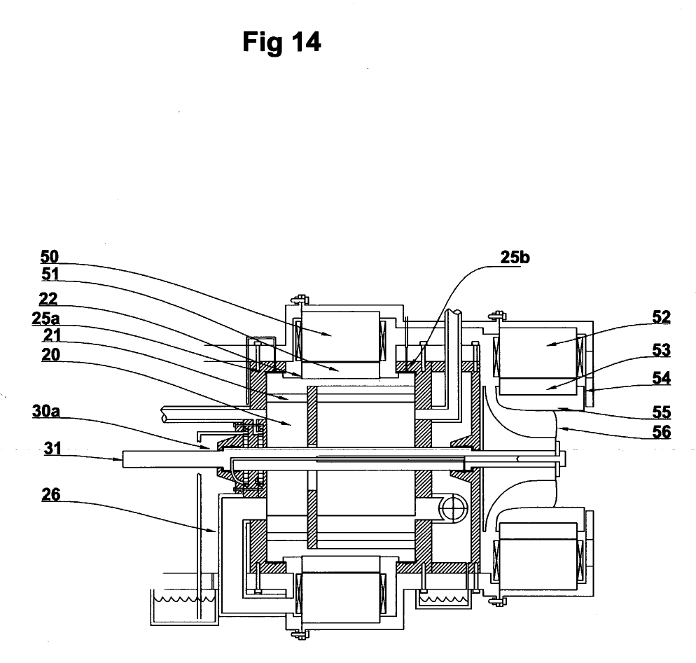

FIG. 14 is a section through the same gerotor engine as in FIG. 13 additionally illustrating the application of the present invention to synchronize the gerotor rotors of the gerotor engine. An outer gerotor rotor alternator stator 50, possibly designed to generate electricity at a frequency which is an integer multiple of the power pulse frequency of the outer gerotor rotor lobe rotation, is constructed to surround the outer gerotor rotor casing 22. The pole pieces 51 of the alternator rotor of the outer gerotor rotor alternator are then embedded into a non-magnetic layer of material 22 which surrounds the compressor and expander outer gerotor rotor and which rotates on bearings 25a and 25b. An inner gerotor rotor alternator stator 52, possibly designed to generate electricity at a frequency which is an integer multiple of the power pulse frequency of the inner gerotor rotor lobe rotation, is constructed to surround the shaft 31 which supports the inner gerotor rotor. The pole pieces 53 of the alternator rotor of the inner gerotor rotor alternator are then embedded into a non-magnetic layer of material 54 which surrounds a hollow drum 55, itself mounted for rotation on shaft 31 which rotatably supports the inner gerotor rotors and the inner gear of the gear pair on bearings 30a and 30b. In this manner the requirement for the gear pair illustrated in FIG. 13 may be eliminated due to the close matching of the two alternators and exciter management of the alternators to match their loading to the power production of the respective gerotor parts to which they are connected.

FIG. 14 also illustrates the placing of a cooling air blower 56 within the rotor according to the present invention. The blower is disposed to provide cooling air at fairly high static pressure to the stator windings of each of the two alternators. Also illustrated is the connection of the compressor inlet 26 to accept intake from the exhaust of the stator winding cooling air, which will cause an increase in engine efficiency due to the increased inlet static pressure, offset by a reduction in compressor efficiency caused by the higher temperature of the inlet air. This design feature allows the alternator windings to be more closely spaced since the cooling air at higher pressure has a greater capacity per unit cross section of cooling air path to carry away heat from the windings. Since high temperature working fluid is the goal of the system, this modification may be found to be beneficial in net, but must be evaluated on a per design basis.

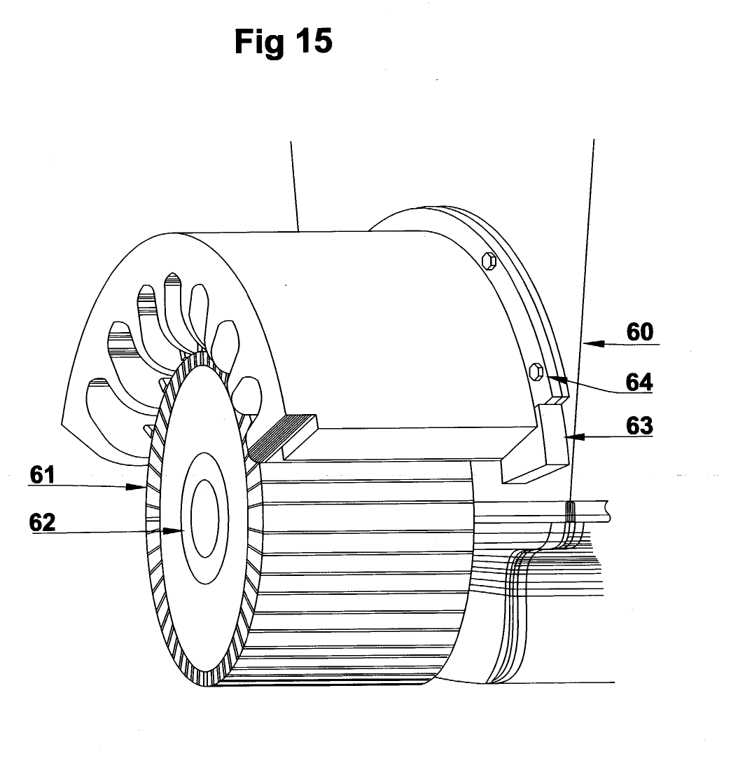

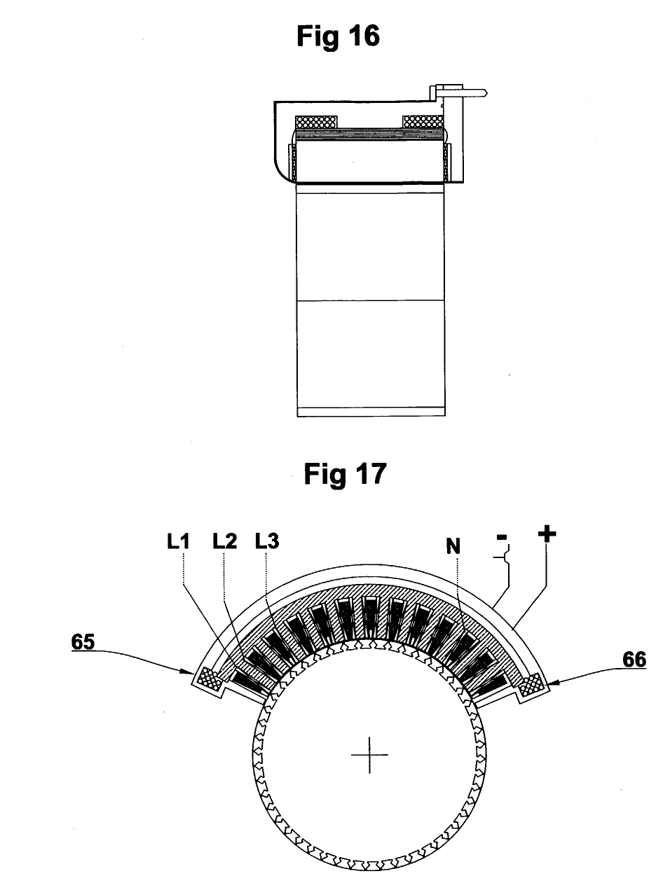

FIG. 15 is a perspective image of a dynamo electric machine constructed according to a third preferred embodiment of the present invention illustrating a stator which surrounds less than 360 degrees of the rotor. This alternator construction is particularly applicable to this purpose since the magnetic paths of the lines of magnetic force used to excite the alternator stator do not flow very far through the rotor in any case. They flow only from a first exciter projection into a first rotor pole piece, then into a stator tooth, through the stator ring to a nearby stator tooth, into a second rotor pole piece and into a second exciter projection to complete the magnetic circuit. This allows for an electrically and dynamically balanced dynamo electric machine to be constructed with both a) a stator which does not fully surround the rotor, b) a rotor which does not expose any electrical circuitry to damage outside of the stator, and c) a minimum of exciter energy required, since the exciter coils are sized to match only that part of the stator which is employed.

FIG. 15 also illustrates having the alternator rotor 61 replace the harmonic balancer at the front of a piston engine 60 such as might be used in an automobile. Either of the dynamo electric machine designs of the present invention are particularly well suited to this application since the large number of rotor poles means the machine does not require a drive system to increase the rotational frequency at idle in order to produce an acceptable power level. As discussed previously, the exciter power can be managed to take over the job of suppressing undesirable harmonic vibrations, and if necessary, the centre of the rotor may still be constructed with a viscous layer 62 to enhance harmonic balance. Not showed for clarity is a thin non-magnetic stainless steel sheet which would completely enclose only the stator portion of the alternator, sealing it from the environment. Cooling is provided from the engine block coolant through heat transfer surfaces at the back of the stator, and possibly by mating or separately piped passages not showed which would conduct engine coolant directly within or around the stator body. Mechanical mounting

I claim:

1) A dynamo electric machine comprising
a) a stator constructed by
i) linking the peripheral portions which are disposed furthest from the rotor of a plurality of armature teeth arranged at equilangular pitches in a circumferential direction
by an annular core back,
and winding around the teeth a plurality of coils composed entirely of coils that are excited by alternating current; and
ii) installing an exciter pole member comprised of
1. a circumferential band of magnetic material surrounding the annular core at an intervening distance to provide magnetic separation therefrom
2. a plurality of teeth equal in number to the armature teeth and projecting alternately from opposite sides of the circumferential band, the teeth shaped so that each one projects between the armature teeth alternately from one side, then from the other side
3. a field coil wound in bobbin fashion proximate to the circumferential band of magnetic material in a manner that a direct current flowing in the coil will cause the teeth projecting from one side of the band to become magnetized as north magnetic poles, and the teeth projecting from the other side of the band to become magnetized as south magnetic poles.
b) a rotor constructed by a plurality of magnetic poles composed of magnetic members arranged at equiangular pitches in the circumferential direction, the magnetic poles being formed into one piece by a base portion composed of a nonmagnetic member, and the rotor being rotatably disposed around an axis of the stator and adjacently to an inner or outer periphery of the stator.

2) A dynamo-electric machine according to claim 1, wherein a ratio of a number of the teeth and a number of the magnetic poles installed into the rotor is [phase count]/[phase count+1].

3) A dynamo electric machine comprising
a) a stator constructed by
i) linking the peripheral portions which are disposed furthest from the rotor of a plurality of armature teeth arranged at equilangular pitches in a circumferential direction
by an annular core back,
and winding around the teeth a plurality of coils composed entirely of coils that are excited by alternating current; and
ii) installing an exciter pole member comprised of
1. a circumferential band of magnetic material surrounding the annular core at an intervening distance to provide magnetic separation therefrom
2. two circumferential rings projecting alternately from opposite sides of the circumferential band toward the center of the rotor, the rings shaped so that each one projects toward and very near to the rotor at each side or end surface of the rotor.
3. a field coil wound in bobbin fashion proximate to the circumferential band of magnetic material in a manner that a direct current flowing in the coil will cause the ring projecting from one side of the band to become magnetized as north magnetic poles, and the ring projecting from the other side of the band to become magnetized as south magnetic pole.
b) a rotor c nstructed by a plurality of magnetic members arranged at equiangular pitches in the circumferential direction, the magnetic poles being formed into one piece by a base portion composed of a nonmagnetic member, and the rotor being rotatably disposed around an axis of the stator and adjacently to an inner or outer periphery of the stator, and the length and shape of the pole ends being shaped so that alternate pole ends project toward alternate sides of the rotor in a manner that alternate poles become magnetized continuously as either north or south magnetic poles.

4) A dynamo-electric machine according to claim 3, wherein the number of the teeth and the number of the magnetic poles installed into the rotor are equal.

5) A dynamo electric machine acting as an electric generator or motor where
a) the dynamo electric machine's magnetic and electrical characteristics are calculated to cause it to not only serve its primary purpose as a generator or motor but also to synchronize mechanically or electrically with its prime mover engine or with a second dynamo electric machine which is also connected to the common prime mover engine and
b) the synchronizing is accomplished for the purpose of serving a mechanical co-ordination or balancing need in the said common prime mover engine.

6) A dynamo electric machine as in claim 5 where
a) the prime mover engine is a gerotor machine or machines which act as a compressor or expander in a heat engine, and
b) the dynamo electric machine is connected mechanically to the outer rotor of the engine compressor or expander and
c) the second dynamo electric machine is connected mechanically to the inner rotor of the engine compressor or expander and
d) the second dynamo electric machine is connected electrically to the first dynamo electric machine and
e) the purpose served in the prime mover is mechanical co-ordination of the rotation of the outer and inner gerotor machine elements.

7) A dynamo electric machine as in claim 5 where
a) the prime mover is a piston engine and
b) the dynamo electric machine has its pole count designed to be an even multiple of the minimum rotational arc between the engine power pulses

8) A dynamo electric machine as in claim 7 where
a) a second similar dynamo electric machine is connected to the opposite end of the engine crank shaft and
b) the said first and second dynamo electric machines are connected together electrically in a manner to transfer vibration or power pulses from each end of the crank shaft jointly or separately to each other or to an external load.

9) A dynamo electric machine where
a) the dynamo electric machine is connected as a generator or motor to a prime mover engine and
b) the exciter magnetic field strength is varied by a control circuit connected to electromagnetic coils which are part or the dynamo electric machine exciter and which are excited electronically so the net magnetic field strength of the entire exciter ranges above and below the average strength required for adequate power generation, and
c) the said exciter field strength variations are accomplished for the specific purpose of damping undesired vibrations or mechanical movement within the prime mover engine.

10) A dynamo electric machine where
a) the dynamo electric machine is connected as a generator or motor to a prime mover engine and
b) the exciter of the said dynamo electric machine is divided electrically into two or more parts radially and
c) the exciter magnetic field strength of individual resulting parts is varied by either
i) magnetic circuit physical design or
ii) by a control circuit connected to magnetic coils excited electrically to cause the net magnetic field strength of individual radial parts to range above and below the average field strength required for adequate power generation, and
d) the said exciter field strength variations are accomplished for the specific purpose of creating essentially directionally fixed radial force vector(s) on the rotor to offset undesired opposite radial force vector(s) existing within the prime mover engine durings its operation.

11) A dynamo electric machine as in claim 10 where
a) the stator power circuits of the dynamo electric machine are also designed, constructed and installed to contribute to the said essentially directionally fixed radial force vector(s).

12) A dynamo electric machine wherein
a) the dynamo electric machine is of the modified Lundel type having both the power windings and the exciter magnets contained within the stator structure
b) the stator is designed to accomplish its purpose while surrounding less than the full circumference of the rotor.

13) A dynamo electric machine as in claim 12 where
a) all or part of the remaining unused circumference of the rotor is occupied by an additional stator serving a separate purpose from the said stator of claim 12.

14) A dynamo electric machine where
a) the dynamo electric machine is of the modified Lundel type having both the power windings and the exciter magnets contained within the stator
b) an axial, centrifugal or turbine blower is constructed within the available unneeded area at the center of the rotor for cooling or any other purpose of the said dynamo electric machine or other machines which may need such service.

15) A dynamo electric machine where
a) the dynamo electric machine is of the modified Lundel type having both the power windings and the exciter magnets contained within the stator
b) a layer or disk of viscous material is constructed within the available unneeded area at the center of the rotor between the driving shaft bore and the magnetic pole area for the purpose of enabling the said dynamo electric machine rotor to automatically dampen undesired vibrations or pulsations within the engine to which the said rotor may be connected.
